(19) United States
(12) Patent Application Publication
(10) Pub. No.: US 2025/0190175 A1
(43) Pub. Date: Jun. 12, 2025

(54) Method and System for Designing and Utilizing Microprogrammable Computational Cores for Health Tests in True Random Number Generators

(71) Applicant: SK hynix Inc., Gyeonggi-do (KR)

(72) Inventor: Siarhei ZALIVAKA, Gdansk (PL)

(21) Appl. No.: 18/530,540

(22) Filed: Dec. 6, 2023

(51) Int. Cl. G06F 7/58

(52) U.S. Cl. CPC G06F 7/588

(57) ABSTRACT

A method and system for producing a health test (HT) processing engine to test a random number source. The method and system receive a set of health tests to program into the HT processing engine, determine operations, constants, and variables used by the set of health tests, map the constants and the variables to a memory buffer in the HT processing engine, generate binary code operational instructions for each operation for each health test in the set of health tests, synthesize the HT processing engine for a chosen hardware platform for processing the binary code operational instructions, and program hardware in the HT processing engine to process the binary code operational instructions with the chosen hardware platform.

### BACKGROUND

### 1. Field

Embodiments of the present disclosure relate to a random number generation.

### DESCRIPTION OF THE RELATED ART

A common scheme for a National Institute of Standards and Technology (NIST) certified true random number generator (TRNG) consists of an entropy source, a conditioning component, and health tests unit. Together these components can generate sequences of true random numbers with targeted statistical characteristics. The entropy source model itself consists of a noise source and a digitalization scheme (in the case of analog noise). The conditioning component is responsible for reducing bias and/or increasing the entropy rate of the resulting output bits.

True random number generators (TRNG) are widely used in the majority of electronic devices for different purposes, e.g., security, data shuffling, noise generation, random sampling, statistical simulation, etc. One area of application is cryptographic algorithms requiring strict correspondence to standards. There are two main standardization institutions for TRNGs, namely National Institute of Standards Technology (NIST) and Bundesamt for Sicherheit in der Informationstechnik (BSI). Different standards for health tests (HTs) are often directed to immediate or continuous testing of Entropy Source (ES) outputs.

### SUMMARY

In one embodiment of the present invention, there is provided a method for producing a health test (HT) processing engine for testing a random number source. The method receives a set of health tests to program into the HT processing engine, determines operations, constants, and variables used by the set of health tests, maps the constants and the variables to a memory buffer in the HT processing engine, generates binary code operational instructions for each operation for each health test in the set of health tests, synthesizes the HT processing engine for a chosen hardware platform (e.g., ASIC or FPGA) for processing the binary code operational instructions, and programs hardware in the HT processing engine to process the binary code operational instructions with the chosen hardware platform.

In one embodiment of the present invention, there is provided a programmable system for testing a random number source. The system has a health test HT processing engine for applying a set of health tests to an entropy source functioning as the random number source; a controller for programming and controlling the HT processing engine; a memory buffer in the HT processing engine; and a program code memory for storing program codes for operations associated with the set of health tests. The controller is configured to receive input directed to a selection of the health tests to be programmed in the HT processing engine, determine operations, constants, and variables used by the set of health tests, map the constants and the variables to the memory buffer, based on the set of the health tests to be programmed, generate binary code operational instructions for each operation for each health test in the set of health tests, synthesize the HT processing engine for a chosen hardware platform for processing the binary code operational instructions, and program the HT processing engine to process the binary code operational instructions with the chosen hardware platform.

In one embodiment of the present invention, there is provided an entropy source coupled to the above-noted system for testing a random number source.

Additional aspects of the present invention will become apparent from the following description.

### BRIEF DESCRIPTION OF THE DRAWINGS

FIG. 1 is a block diagram of a HT processing engine in accordance with one embodiment of the present invention;

FIG. 2 is a diagram depicting one implementation of a Repetitive Count Test (RCT) algorithm in accordance with one embodiment of the present invention;

FIG. 3 is a diagram depicting a correspondence between the code in FIG. 2 and the notation of RCT in accordance with one embodiment of the present invention;

FIG. 4 is a diagram depicting one implementation of an Adaptive Proportion Test (APT) algorithm in accordance with one embodiment of the present invention;

FIG. 5 is a diagram depicting one implementation of a Monobit Test (MBT) algorithm in accordance with one embodiment of the present invention; and

FIG. 6 is a flowchart illustrating a method for producing a health test (HT) processing engine for testing a random number source in accordance with another embodiment of the present invention.

### DETAILED DESCRIPTION

Various embodiments are described below in more detail with reference to the accompanying drawings. The present invention may, however, be embodied in different forms and thus should not be construed as limited to the embodiments set forth herein. Rather, these embodiments are provided so that this disclosure is thorough and complete and fully conveys the scope of the present invention to those skilled in the art. Moreover, reference herein to “an embodiment,” “another embodiment,” or the like is not necessarily to only one embodiment, and different references to any such phrase are not necessarily to the same embodiment(s). Throughout the disclosure, like reference numerals refer to like parts in the figures and embodiments of the present invention.

The invention can be implemented in numerous ways, including as a process; an apparatus; a system; a computer program product embodied on a computer-readable storage medium; and/or a processor, such as a processor suitable for executing instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being suitable for performing a task may be implemented as a general component that is temporarily configured to perform the task at a given time or a specific component that is manufactured to perform the task. As used herein, the term ‘processor’ or the like refers to one or more devices, circuits, and/or processing cores suitable for processing data, such as computer program instructions.

A detailed description of embodiments of the invention is provided below along with accompanying figures that illustrate aspects of the invention. The invention is described in connection with such embodiments, but the invention is not limited to any embodiment. The scope of the invention is limited only by the claims. The invention encompasses numerous alternatives, modifications and equivalents within the scope of the claims. Numerous specific details are set forth in the following description in order to provide a thorough understanding of the invention. These details are provided for the purpose of example; the invention may be practiced according to the claims without some or all of these specific details. For clarity, technical material that is known in technical fields related to the invention has not been described in detail so that the invention is not unnecessarily obscured.

The usual practice in the design of TRNGs is to implement HTs required by the standard(s) and additional tests for more sophisticated testing of the generated random numbers entropy. Yet, a fixed implementation cannot be further configured to append additional tests. Indeed, if the fixed implementation was modified to accommodate the additional tests, this modification would require significant hardware overhead, and could result in additional hardware that is even larger than the entropy source (ES) itself.

To address these consequences, the present invention provides one or more programmable computational cores for health tests implementation. Although additional memory is required to buffer the generated random numbers and to store health test micro-programs, the programmable computational cores of the present invention provide a more flexible method of implementing different health test (HT) configurations, which can be adapted to (or programmed for) different security standards and customer requirements.

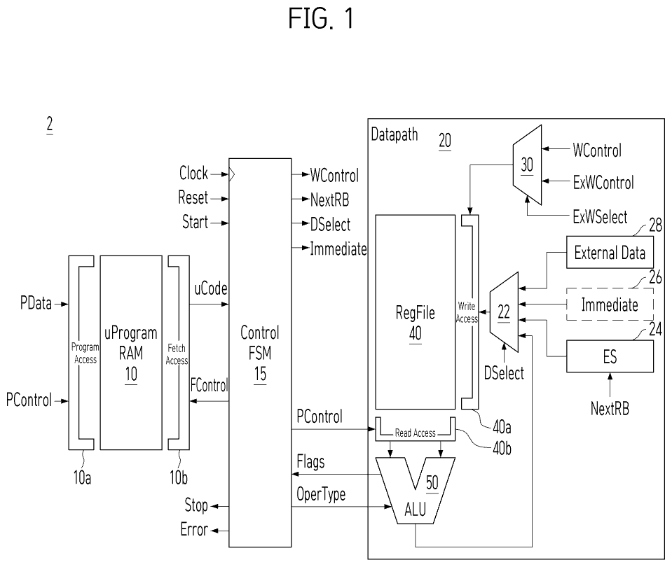

One architecture of an HT processing engine is shown by the microprogrammable computational core 2 depicted in FIG. 1. Detailed operations of the microprogrammable computational core 2 are described below. Structurally, the microprogrammable computational core 2 includes a random access memory (RAM) 10 holding the microprogram instruction (uCode in FIG. 1) which is transferred from RAM to a control Finite State Machine (FSM) 15. The microprogrammable computational core 2 also includes datapath circuitry 20. Inputs to RAM 10 (including PData and PControl) are transferred by program access bus 10a. PData represents the microprogram data. PControl represents the microprogram instructions.

Outputs from RAM 10 are transferred by fetch access bus 10b. Control FSM 15 functions as a controller for the microprogrammable computational core 2 and provides control signals such as WControl, ExWControl, and ExWSelect to datapath circuitry 20. The datapath circuitry 20 includes an input data multiplexer (DMUX) 22, Register File (RegFile) 40 serving as a memory buffer to store variables and constants, and Arithmetic Logic Unit (ALU) 50. DMUX 22 receives inputs from a) ES (Entropy Source) 24, b) Immediate source 26 providing constant values (of the microprogram) from RAM 10, c) an external data source 28, and d) a result of an operation in ALU 50 and selects one of them based on the DSelect signal value. After selection, the result selected is passed to RegFile 40. The datapath circuitry 20 further includes a write control signal multiplexer (WMUX) 30 receiving write control signals such as WControl, ExWControl from FSM 15 and selects one of them based on ExWSelect signal value.

DMUX 22 is a multiplexer used for selecting the source of data (Entropy source, Immediate value, External data or result of ALU operation) based on the DSelect signal. WMUX 30 is a multiplexer used for selecting the write control signal from either FSM (WControl) or external data source (ExWControl) based on the ExWSelect signal. Outputs from DMUX 22 and WMUX 30 are transferred to RegFile 40 by write access bus 40a.

RAM 10 as shown in FIG. 1 may receive PData and PControl signals as well as receiving an FControl signal from control FSM 15. FControl is a fetch control signal from FSM which is used to fetch the data from the RAM. RAM 10 may output microprogram instruction (uCode) to control FSM 15 Control FSM 15 may receive clock, reset, and start signals and may output stop and error signals. Further, control FSM 15 may output WControl signal (a signal for write control), the DSelect signal, Immediate signals (containing immediate values or constants) for WMUX 30, and a NextRB signal for ES 24. NextRB is a signal for the ES to generate the next Random Bit. Inputs to RegFile 40 are transferred by write access bus 40a. Outputs from RegFile 40 are transferred by read access bus 40b. Additionally, control FSM 15 may output a read control signal PControl for RegFile 40 and output an Operational Type signal (OperType) for ALU 50. ALU 50 may output Flags signal indicating the result of the performed operation.

In one embodiment, ES 24 outputs an M-bit random bit sequence (rb₁, rb₂, rb₃, . . . , rb_{M}), which may be stored in a memory or buffer, for example in RegFile 40. The sequence may be stored in the memory at designated addresses, and/or stored as a sequence of memory addresses.

In one embodiment of the present invention, there is provided an inventive method (and resultant system) which can be characterized by nine stages for synthesis of the microprogrammable computational core(s) of the present invention. Below are those nine stages shown for illustrative purposes, although the present invention is not limited to all of these stages and may include other stages:
1. Determination/identification of a set of HTs to be implemented.
2. Development of a notation for a selected set of HTs.
3. Determination of operations, constants, and variables required for implementation of the selected set of health tests.
4. Configuring a datapath for a computational core.
5. Development of an Instruction Set Architecture (ISA).
6. Coding of the selected set of HTs according to the ISA.
7. Mapping of constants and variables to memory buffers.
8. Determination of an instruction format in binary code.
9. Hardware synthesis of a health test processing engine (i.e., a microprogrammable computational core) taking into account the memory buffer(s) requirements. The synthesis may be performed with application specific integrated circuits (ASIC) and/or field programmable gate arrays (FPGA).

Accordingly, in one embodiment of the present invention, a synthesized computational core can be used for different sets of HTs by loading different micro-programs. Based on changing standards and/or changing requirements, the microprogrammable computational cores can be programmed to perform the selected set of HTs in a flexible way. In one embodiment, this inventive method (and resultant system) may result in a reduced hardware overhead (as demonstrated below) compared to conventional HT implementations, where fixed hardware is used for each HT being run.

Below are specifics as to the inventive method (and resultant system) noted above. This description is illustrative and non-limiting.

### Stage 0. Fundamentals.

a. The ES has a bitwise output channel.
b. A logic circuit external to the ES (such as for example data multiplexer 22 of FIG. 1) obtains the next random bit rb from the ES. If the value of rbₜ refers to the current or instantaneous random bit produced by ES, then the next random value from ES after rbₜ will be rbₜ₊₁.
c. A memory associated with the logic circuit (such as for example Register File 40 of FIG. 1) may store and/or buffer the random bit sequence where M is the memory size, with the memory storing the random bit sequence (rb₁, rb₂, rb₃, . . . , rb_{M}), where rbᵢ is one random bit stored in the memory at address i. In this case, the value of rbᵢ is the stored value of rbₜ. Therefore, when a fetched (or retrieved) value of rbᵢ is interpreted as the current random value, then the value of rbᵢ₊₁ is the next value in space (in the case of existing memory) or in time (in the case of an ES without memory).
d. Health Tests utilized here may operate with:
   i. values of rbᵢ and rbᵢ₊₁;
   ii. all possible addresses i∈[1,M]; and/or
   iii. with a sequence of addresses (window with size W≤M).

Stage 1. Health Tests Identification: The set of HTs selected basically contains tests required by the standard being followed and/or any additional tests imposed by a customer or specific for the area of application. For example, consider two tests required by NIST standard, namely Repetition Count Test (RCT) and Adaptive Proportion Test (APT) and one additional test, namely Monobit Test (MBT) for better entropy assessment. Details of implementation of these specific HTs are provided below, but the present invention is not limited to these specific HTs or this illustrated combination of HTs.

Stage 2. Notation: A notation (similar to existing memory tests notations) is used to make the test description compact. The notation may also be similar to the mathematical description of the algorithm(s). For the health tests illustrated in this disclosure, the notation rules are as follows.
a. [symbol] _{i=L}^{H} sequential iteration of address i of Memory from L to H (L<H).
b. {op₁; op₂; . . . ; op_{R}}—phase block with sequential operators opⱼ(j∈[1,R]) within the current iteration of addresses. The phase block may be in three modes:
   i. { . . . }—all operators are executed once;
   ii. [symbol] ᵢ₌₁^{T}{ . . . }—all operators are executed repeatedly T times;
   iii. [symbol] ᵢ₌₁^{T}{ . . . [symbol] ⱼ₌₁^{S}{ . . . } . . . }—nested phases, boundary operators will be executed T times, nested phase operators—S×T times.
c. opⱼ—nested ternary operator (e.g., analog from C++ programming language), includes a condition and two expressions (if condition is true then execute expression_1 else−execute expression_2):
   i. opⱼ=(condition ?expression_1: expression_2);
   ii. opⱼ=(condition ?expression_1);
   iii. opⱼ=(expression_1);
   iv. where expression_1 or expression_2 can be another opₖ.

Stage 3. Operations, Constants, Variables: This stage includes designing a set of operations for implementing the set of selected HTs in the hardware shown in FIG. 1. Also, constants and variables for the different types of HTs are utilized to develop micro-program(s) for implementing the selected tests. The operations, constants and variables for the selected HTs are described below.

3.1. Operations: The operations described below can be considered as the same as in C++ programming language: logic, bitwise, arithmetic, etc. One additional operation used here is exit. In one embodiment, the execution of exit terminates all phases of the health test operation. When exit is not presented, then all phases and operators will be executed.

3.2. Constants: Constants can be of Two Types:
i. Integer constants which can be used in any operations;
ii. User defined constants which are predefined for all phases and may be presented with capital letters.

3.3. Variables: All variables are integers by default and may be represented with small letters. Variables can be initialized with integer constants. Based on this set of notation rules, operations, constants and variables, simple examples of the notation use are illustrated below.
a. XORing all cells in Memory:

$$\{ ( b = 0 ) \} {⇑}_{i = 1}^{M} \{ ( b \hat{}= {rb}_{i} ) \}$$

b. Decimal sum the first 10 cells in Memory:

$$\{ ( b = 0 ) \} {⇑}_{i = 1}^{M} \{ ( i < 11 ? b += {rb}_{j} : exit ) \}$$

c. Counting all ones in Memory:

$$\{ ( b = 0 ) \} {⇑}_{i = 1}^{M} \{ ( b += {rb}_{i} ) \}$$

d. Counting all cells by a template V at odd Memory addresses. Template V indicates that cells in the memory should be equal to this value (e.g., 5, M, i*i, b/M, etc.) which may be a variable or an expression:

$$\{ ( b = 0 ) \} {⇑}_{i = 1}^{M} \{ ( i \& 1 ? ( {rb}_{i} == V ? b += {rb}_{i} ) ) \}$$

Similarly, the notation for the health tests noted above (RCT, APT, and MBT) is illustrated as follows.
a. Repetition Count Test (threshold constant C):

$$\{ ( b = 1 ) \} {⇑}_{i = 1}^{M} \{ ( {rb}_{i} == {rb}_{i + 1} ? b ++ : ( b >= C ? exit : b = 1 ) ) \}$$

b. Adaptive Proportion Test (threshold constant C, bit window width W):

$${⇑}_{i = 1}^{M} \{ \{ ( b = 1 ) ; ( a = {rb}_{i} ) \} {⇑}_{j = 1}^{W - 1} \{ ( {rb}_{j} == a ? b ++ : ( b >= C ? exit ) ) \} \}$$

c. Monobit Test (threshold constants CL and CH, bit window width W):

$${⇑}_{i = 1}^{M} \{ \{ ( b = 1 ) ; ( a = {rb}_{i} ) \} {⇑}_{j = 1}^{W - 1} \{ ( {rb}_{j} == a ? b ++ : ( b <= CL ? exit : ( b >= CH ? exit ) ) ) \} \}$$

Stage 4. Datapath. Based on the computational flow developed for a selected health test set, the datapath configuration determines the sources of data, the interaction with FSM 15 and the microcode, the implementation of ALU 50 and the structure of the required memory buffers in RegFile 40. One example of a configured data path for the health tests is described below.

Variables and constants for the RCT, APT and MBT health tests are presented in Table 1.

TABLE 1

| | RCT | APT | MBT |
|---|---|---|---|
| Variables | b, i, rbᵢ, rbᵢ₊₁ | a, b, i, j, rbᵢ, rbᵢ₊₁ | a, b, i, j, rbᵢ, rbᵢ₊₁ |
| Constants | 1, C, M | 1, C, W, M | 1, CL, CH, W, M |

Operations or the RCT, AP and MBT ea tests are presented in Table 2.

TABLE 2

| | RCT | APT | MBT |
|---|---|---|---|
| Data Transfer | b = 1 | b = 1, a = rbᵢ | b = 1, a = rbᵢ |
| Arithmetic | b++ | b++, j++ | b++, j++ |
| Relational | rbᵢ == rbᵢ₊₁, | rbᵢ == a, | rbᵢ == a, |
| | b >= C | b >= C, j > W | b <= CL, |
| | | | b >= CH, j > W |
| Branch | exit, goto | exit, goto | exit, goto |

Based on Table 1 and Table 2, the architecture of a microprogrammable computational core can be configured as shown in FIG. 1. The datapath 20 shown in FIG. 1 includes RegFile 40 as a memory or buffer to store variables and constants.

There are four data sources for RegFile 40:
1. External Data can be loaded from external sources, for example storing the constants (e.g., C, W, M) of the RCT, APT and MBT health tests.
2. Immediate value. The constant values from uCode, generated by Control FSM 15. For example, for i=0, if the uCode includes constant, its value is generated by FSM and used as immediate value.
3. Random data from the ES 24.
4. The result of an operation from ALU 50, which can be used for register-register transfer.

ALU 50 may execute a nest operation over single or two registers:
1. Incrementing (++).
2. Comparison: equal (==), greater or equal (>=), greater (>) and less or equal (<=).

The result of the executed operation in ALU 50 can be sent back to RegFile 40 or to Control FSM 15 as a status Flag.

Stage 5. Instruction Set Architecture. During this stage, assembler-like instructions are developed in order to code the microprograms for the considered tests set. Example of the ISA for RCT, APT and MBT is shown below.

### RegFile 40 Data Transfer Instructions:

| | | |
|---|---|---|
| a. Register-register: | mov reg_i, reg_j | // Copy the value of reg_into reg_i |
| b. Register-constant: | mov reg_i, immediate | // Write immediate value into reg_i |
| c. ES-register: | getrb reg_i | // Write next value of random bit into |
| | | // reg_i |
| a. Increment: | inc reg_i | // Increment the value of reg_i |
| b. Test if equal: | te reg_i, reg_j | // Test if reg_i == reg_j |
| c. Test if greater or equal: | tge reg_i, reg_j | // Test if reg_i >= reg_j |
| d. Test if greater: | tg reg_i, reg_j | // Test if reg_i > reg_j |
| e. Test if less or equal: | tl reg_i, reg_j | // Test if reg_i < reg_j |

### Alu 50 Instructions:

| | | |
|---|---|---|
| a. Increment: | inc reg_i | // Increment the value of reg_i |
| b. Test if equal: | te reg_i, reg_j | // Test if reg_i==reg_j |
| c. Test if greater or equal: | tge reg_i, reg_j | // Test if reg_i>=reg_j |
| d. Test if greater: | tg reg_i, reg_j | // Test if reg_i>reg_j |
| e. Test if less or equal: | tl reg_i, reg_j | // Test if reg_i<reg_j |

### Branch and Jump Instructions:

| | | | |
|---|---|---|---|
| a. | Exit type: | exit code | // Normal/Abnormal |
| | | | // (code = 1/0) exit. |
| b. | Unconditional jump: | goto address | // Jump to the address. |
| c. | Testing branch | txx reg_i, reg j | // If test is passed then jump |
| | | | // through |
| | | XX = {e, ge, g, I} | // else - jump next. |

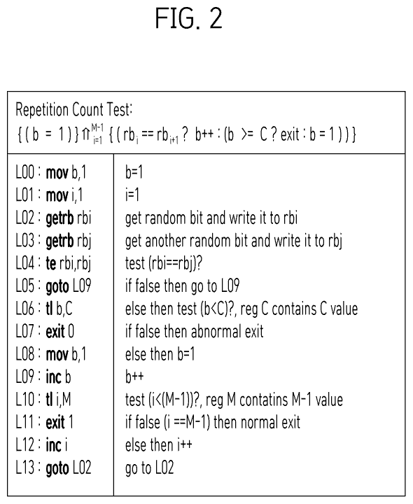

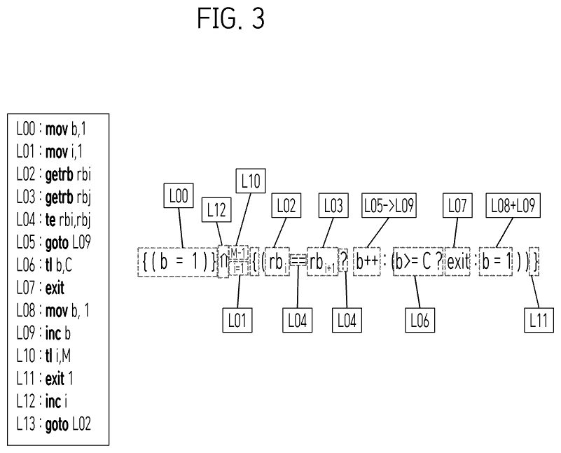

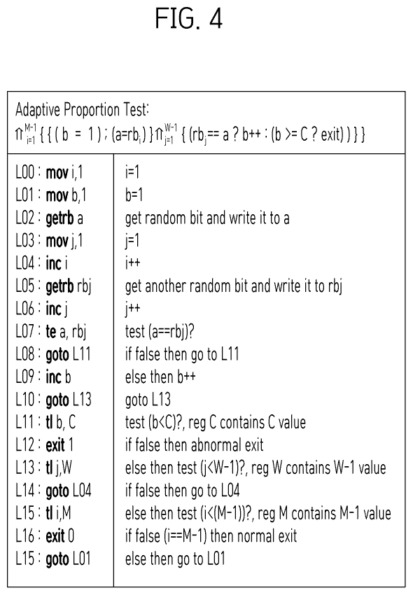

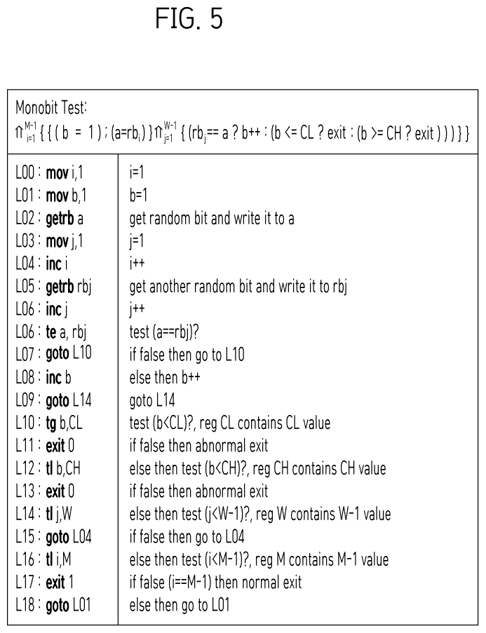

Stage 6. Test Set Coding. Based on the instruction set designed in Stage 5, the codes implementing the algorithms of the selected tests set are developed for example by an individual or individuals and loaded into RAM. Examples of implementation of the selected health tests noted above are shown FIGS. 2-5. The implementation of the RCT algorithm is shown in FIG. 2. FIG. 3 shows a correspondence between the code in FIG. 2 and the notation of RCT. The implementation of the APT algorithm is shown in FIG. 4. The implementation of the MBT algorithm is shown in FIG. 5.

Stage 7. Memory Buffers. The variables used in the code for each test from the set are mapped to addresses in the memory buffers where values of the variables will be stored. An estimate of the number of the registers required in the hardware implementation may be made. Based on this information, a model of the register file (for example the requirements for RegFile 40 as a memory buffer for RCT, APT and MBT) is shown in Table 3 below.

TABLE 3

| | RCT | APT | MBT |
|---|---|---|---|
| Variables (registers) | b, i, rbi, rbj | a, b, i, j, rbj | a, b, i, j, rbj |
| Constants (registers) | C, M | C, W, M | CL, CH, W, M |
| Immediate | 0, 1 | 1 | 1 |
| Number of registers | 6 | 8 | 9 |
| in RegFile 40 | | | |

Table 4 below shows the mapping of the variables and constants to registers for each RCT, APT and MBT test.

TABLE 4

| RCT | | | APT | | | MBT | | |
|---|---|---|---|---|---|---|---|---|
| Address | Mnemonic | Value | Address | Mnemonic | Value | Address | Mnemonic | Value |
| 0000 | R0 | M | 0000 | R0 | M | 0000 | R0 | M |
| 0001 | R1 | C | 0001 | R1 | C | 0001 | R1 | CL |
| 0010 | R2 | b | 0010 | R2 | W | 0010 | R2 | CH |
| 0011 | R3 | i | 0011 | R3 | a | 0011 | R3 | W |
| 0100 | R4 | rbi | 0100 | R4 | b | 0100 | R4 | a |
| 0101 | R5 | rbj | 0101 | R5 | i | 0101 | R5 | b |
| | | | 0110 | R6 | j | 0110 | R6 | i |
| | | | 0111 | R7 | rbj | 0111 | R7 | j |
| | | | | | | 1000 | R8 | rbj |

Stage 8. Instruction Format. Statistics such as for example the frequency of using each instruction for RCT, APT and MBT health tests, in one embodiment, can be used to determine the bit width for the instructions. This stage also determines the memory buffer size for the selected set of health tests to be implemented. One example of determining the format of instruction for the set of health tests is shown below.

The frequency of using each instruction for RCT, APT and MBT is presented in Table 5.

TABLE 5

| Instruction | RCT | APT | MBT |
|---|---|---|---|
| mov reg_i, reg_j | — | — | — |
| mov reg_i, immediate | ••• | ••• | ••• |
| getrb reg_i | •• | •• | •• |
| inc reg_i | •• | ••• | ••• |
| te reg_i, reg_j | • | • | • |
| tge reg_i, reg_j | — | — | — |
| tg reg_i, reg_j | — | — | • |
| tl reg_i, reg_j | •• | ••• | ••• |
| exit | • | • | •• |
| goto | •• | •••• | •••• |
| Total Number of | 14 | 18 | 20 |
| Instructions | | | |

In this example, eight (8) instructions from the initial ten (10) instructions were used. 3-bit operation type was used to decode each instruction. A maximum of 20 words in uProgram RAM 10 was used to store the largest set of health test instructions, that is the MBT had 20 instructions. To address any stored instruction (uCode) in uProgram RAM 10, a 5-bit address can be used. The instruction format is shown in Table 6 in binary code format.

TABLE 6

| | 11-bit Opcode | | | | | | | | | | |
|---|---|---|---|---|---|---|---|---|---|---|---|
| | OT | | | Field1 | | | | Field2 | | | |
| Mnemonic | 10 | 9 | 8 | 7 | 6 | 5 | 4 | 3 | 2 | 1 | 0 |
| mov ra, im | 0 | 0 | 0 | ra | ra | ra | ra | im | im | im | im |
| getrb ra | 0 | 0 | 1 | ra | ra | ra | ra | — | — | — | — |
| inc ra | 0 | 1 | 0 | ra | ra | ra | ra | — | — | — | — |
| te ra, rb | 0 | 1 | 1 | ra | ra | ra | ra | rb | rb | rb | rb |
| tg ra, rb | 1 | 0 | 0 | ra | ra | ra | ra | rb | rb | rb | rb |
| tl ra, rb | 1 | 0 | 1 | ra | ra | ra | ra | rb | rb | rb | rb |
| exit c | 1 | 1 | 0 | — | — | — | — | — | — | — | c |
| goto a | 1 | 1 | 1 | — | — | — | a | a | a | a | a |

ra, rb—bits in 4-bit address of the register file
im—bits in 4-bit immediate constant
c—constant single bit flag for exit instruction
a—bits in 5-bit address in RAM for micro instructions
OT—operation type

In one embodiment of the present invention, the uProgram codes such as those designated by the mnemonics shown in Tables 5 and 6 are compiled into uCodes producing a set of binary code operational instructions. Table 7 shows the binary code implementation for RCT where the uCode shown represents binary code operational instructions.

TABLE 7
RegFile (RCT)

| Address | Mnemonic | Value |
|---|---|---|
| 0000 | R0 | M |
| 0001 | R1 | C |
| 0010 | R2 | b |
| 0011 | R3 | i |
| 0100 | R4 | rbi |
| 0101 | R5 | rbj |
| Address | uProgram (RCT) | uCode (RCT) |
| 00000 | L00: mov b, 1 | 000-0010-0001 |
| 00001 | L01: mov i, 1 | 000-0011-0001 |
| 00010 | L02: getrb rbi | 001-0100-0000 |
| 00011 | L03: getrb rbj | 001-0101-0000 |
| 00100 | L04: te rbi, rbj | 011-0100-0101 |
| 00101 | L05: goto L09 | 111-0000-1001 |
| 00110 | L06: tl b, C | 101-0010-0001 |
| 00111 | L07: exit 0 | 110-0000-0000 |
| 01000 | L08: mov b, 0 | 000-0010-0000 |
| 01001 | L09: inc b | 010-0010-0000 |
| 01010 | L10: tl i, M | 101-0011-0000 |
| 01011 | L11: exit 1 | 110-0000-0001 |
| 01100 | L12: inc i | 010-0011-0000 |
| 01101 | L13: goto L02 | 111-0000-0010 |

Table 8 shows the binary code implementation for APT where thee uCode shown represents binary code operational instructions.

TABLE 8
RegFile (APT)

| Address | Mnemonic | Value |
|---|---|---|
| 0000 | R0 | M |
| 0001 | R1 | C |
| 0010 | R2 | W |
| 0011 | R3 | a |
| 0100 | RA | b |
| 0101 | R5 | i |
| 0110 | R6 | j |
| 0111 | R7 | fbi |
| Address | aProgram (APT) | uCode (APT) |
| 00000 | L00: mov i, 1 | 000-0101-0001 |
| 00001 | L01: mov b, 1 | 000-0100-0001 |
| 00010 | L02: getrb a | 001-0011-0000 |
| 00011 | L03: mov j, 1 | 000-0110-0001 |
| 00100 | L04: inc i | 010-0101-0000 |
| 00101 | L05: gefrb rbj | 001-0111-0000 |
| 00110 | L06: inc j | 010-0110-0000 |
| 00111 | L07: te a, rbj | 011-0011-0111 |
| 01000 | L08: goto L11 | 111-0000-1011 |
| 01001 | L09: inc b | 010-0100-0000 |
| 01010 | L10: goto L13 | 111-0000-1101 |
| 01011 | L11: tl b, C | 101-0100-0001 |
| 01100 | L12: exit 0 | 110-0000-0000 |
| 01101 | L13: tl j, W | 101-0110-0010 |
| 01110 | L14: goto L04 | 111-0000-0100 |
| 01111 | L15: tl i, M | 101-0101-0000 |
| 10000 | L16: exit 1 | 110-0000-0001 |
| 10001 | L17: goto L01 | 111-0000-0001 |

Table 9 shows the binary code implementation for MBT where thee uCode shown represents binary code operational instructions.

TABLE 9
RegFile (MBT)

| Address | Mnemonic | Value |
|---|---|---|
| 0000 | R0 | M |
| 0001 | R1 | CL |
| 0010 | R2 | CH |
| 0011 | R3 | W |
| 0100 | R4 | a |
| 0101 | R5 | b |
| 0110 | R6 | i |
| 0111 | R7 | j |
| 1000 | R8 | rbj |
| Address | uProgram (MBT) | uCode (MBT) |
| 00000 | L00: mov i, 1 | 000-0110-0001 |
| 00001 | L01: mov b, 1 | 000-0101-0001 |
| 00010 | L02: getrb a | 001-0100-0000 |
| 00011 | L03: mov j, 1 | 000-0111-0001 |
| 00100 | L04: inc i | 010-0110-0000 |
| 00101 | L05: gefrb rbj | 001-1000-0000 |
| 00110 | L06: inc j | 010-0111-0000 |
| 00111 | L06: te a, rbj | 011-0100-1000 |
| 01000 | L07: goto L10 | 111-0000-1011 |
| 01001 | L08: inc b | 010-0101-0000 |
| 01010 | L09: goto L14 | 111-0000-1111 |
| 01011 | L10: tg b, CL | 100-0101-0001 |
| 01100 | L11: exit 0 | 110-0000-0000 |
| 01101 | L12: tl b, CH | 101-0101-0010 |
| 01110 | L13: exit 0 | 110-0000-0000 |
| 01111 | L14: tl j, W | 101-0111-0011 |
| 10000 | L15: goto L04 | 111-0000-0100 |
| 10001 | L16: tl j, M | 101-0110-0000 |
| 10010 | L17: exit 1 | 110-0000-0001 |
| 10011 | L18: goto L01 | 111-0000-0001 |

Under these constraints, the size of RAM 10 (in bits) for micro instructions is as follow:

$$a . RCT : 14 \times 11 = 154$$

$$b . APT : 18 \times 11 = 198$$

$$c . MBT : 20 \times 11 = 220$$

As a result, the maximal nearest fully addressable RAM size is 2⁵×11=352 bits. The utilized memory is sufficient for executing any test from the test set of RCT, APT or MBT.

Each uCode controlled by FSM 15 may execute in three system clocks: Fetch->Decode->Execute.

Fetch: fetches uCode from uProgram RAM 10 and writes it into an Instruction Register IR (such as RegFile 40).

Decode: decodes the type of fetched uCode, reads the Immediate data (constants or branch address), or reads the random bit value or the value of selected registers.

Execute: executes uCode, compares registers for txx instructions, writes data (constant, random data, incrementing data) to selected register, writes the new value of PC: PC=PC+1 by the default, PC=(branch address) for goto, PC=PC+2 if txx returns True Flag, PC=PC for stop and exit instructions.

Stage 9. Hardware Synthesis. Based on the selected set of HTs, this stage synthesizes the computational core (e.g., synthesizes the microprogrammable computational core 2) for the entropy source to be tested. In various embodiments of the present disclosure, RCT, APT and MBT can be synthesized with a Xilinx ZYNQ-7000 FPGA (xc7z010clg400) programmed to execute the binary instruction set using the memory requirements noted above. The hardware overhead for the computational core is summarized in Table 10 where the number or utilization percentage of look up tables LUT, LUTRAMs, and flip flops FF is shown.

TABLE 10

| Resource | Utilization | Available | Utilization, % |
|---|---|---|---|
| LUT | 104 | 17600 | 0.59 |
| LUTRAM | 32 | 6000 | 0.53 |
| FF | 20 | 35200 | 0.06 |

On the other hand, when these three tests (RCT, APT, and MBT) are implemented in hardware without a microprogrammed computational engine. The overhead for direct implementation of RCT, APT, and MBT together is shown in Table 11.

TABLE 11

| Resource | Utilization | Available | Utilization, % |
|---|---|---|---|
| LUT | 175 | 17600 | 0.99 |
| LUTRAM | 0 | 6000 | 0.00 |
| FF | 100 | 35200 | 0.28 |

As seen from a comparison of Tables 10 and 11, the inventive microprogrammable health test (HT) processing engine is 60% smaller by lookup tables (LUTs) and 5 times smaller by flip-flops (FFs). However, the inventive microprogrammable design requires additional memory buffers (e.g., more LUTRAM) while providing better flexibility in terms of the number of tests and their types.

In one embodiment, the direct hardware implementation of the set of HTs has better performance when all three tests are executed in parallel. In another embodiment, the inventive method (and resultant system) in one embodiment may implement all three tests by combining the three algorithms for each test into one joint algorithm or by using three programmable computational cores instead of one.

### Operational Method

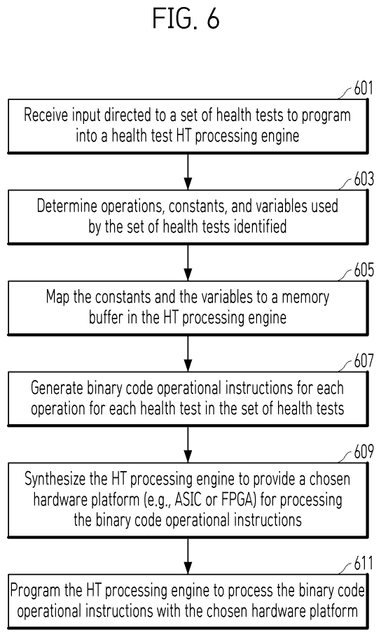

FIG. 6 is a flowchart illustrating a method for producing a health test (HT) processing engine for testing a random number source. The method at 601 receives input directed to a set of health tests to program into a health test HT processing engine. At 603, the method determines operations, constants, and variables used by the set of health tests identified. At 605, the method maps the constants and the variables to a memory buffer in the HT processing engine. At 607, the method generates binary code operational instructions for each operation for each health test in the set of health tests. At 609, the HT processing engine is synthesized for a chosen hardware platform for processing the binary code operational instructions. At 611, the method programs the HT processing engine (e.g., microprogrammable core 2) to process the binary code operational instructions with the chosen hardware platform.

The method of FIG. 6 may further comprise developing an instruction set for each operation for each of the health tests identified, and generating the binary code operational instructions from the instruction set. The method of FIG. 6 may further comprise loading the binary code operational instructions into a program code memory for execution by the HT processing engine.

The method of FIG. 6 may further comprise generating notations for the operations used in each of the health tests and converting the notations into program instructions. The method of FIG. 6 may further comprise ordering the program instructions according to algorithms required by the health tests to produce an ordered instruction set. The ordered instruction set may be compiled into the binary code operational instructions.

The method of FIG. 6 may further comprise configuring a datapath for the HT processing engine. The configured datapath may provide data bits from an entropy source functioning as the random number source to the memory buffer, and provide to an arithmetic logic unit, configured to process the data bits from the entropy source, a) the data bits and b) the constants and the variables used by the set of health tests using the binary code operational instructions. The method of FIG. 6 may further comprise selecting at least one of the binary code operational instructions for processing by the arithmetic logic unit.

The method of FIG. 6 may further comprise combining the binary code operational instructions for each of the health tests into a joint instruction set. The method of FIG. 6 may further comprise processing the binary code operational instructions for each of the health tests in parallel.

The method of FIG. 6 may further comprise hardware programming a field programmable array to process the operational instructions.

In another embodiment of the invention, there is provided a programmable system for testing a random number source, the system has a health test HT processing engine for applying a set of health tests to an entropy source functioning as the random number source; a controller for programming and controlling the health test processing engine; a memory buffer in the HT processing engine; and a program code memory for storing program codes for operations associated with the set of health tests. The controller is configured to: receive input directed to a selection of the health tests to be programmed in the HT processing engine; determine operations, constants, and variables used by the set of health tests; map the constants and the variables to the memory buffer, based on the set of the health tests to be programmed, generate binary code operational instructions for each operation for each health test in the set of health tests; and program the HT processing engine to process the binary code operational instructions.

This system in one embodiment has a data multiplexer configured to select data at least from the entropy source for storage into the memory buffer; an arithmetic logic unit configured to process the data from the entropy source using the binary code operational instructions; and a program multiplexer configured to select for the arithmetic logic unit at least one or more of the binary code operational instructions to be used by the arithmetic logic unit.

The controller in one embodiment is configured to develop an instruction set for each operation for each of the health tests identified, and generate the binary code operational instructions from the instruction set. The controller in another embodiment is configured to load the binary code operational instructions into a program code memory for execution by the HT processing engine.

The controller in one embodiment is configured generate notations for the operations used in each of the health tests; and convert the notations into program instructions. The controller in another embodiment is configured to order the program instructions according to algorithms required by the health tests to produce an ordered instruction set. The controller in still another embodiment is configured to compile the ordered instruction set into the binary code operational instructions. The controller in yet another embodiment is configured to combine the binary code operational instructions for each of the health tests into a joint instruction set. In another embodiment, the controller may process the binary code operational instructions for each of the health tests in parallel.

Finally, an entropy source can be coupled to the programmable system described above.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, or a combination of one or more of them. Apparatus, devices, and machines for processing data in the invention can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network. The computer program can be embodied as a computer program product as noted above containing a computer readable medium.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations, one or more features from a combination can in some cases be excised from the combination, and the combination may be directed to a sub-combination or variation of a sub-combination.

Although the foregoing embodiments have been illustrated and described in some detail for purposes of clarity and understanding, the present invention is not limited to the details provided. There are many alternative ways of implementing the invention, as one skilled in the art will appreciate in light of the foregoing disclosure. The disclosed embodiments are thus illustrative, not restrictive. The present invention is intended to embrace all modifications and alternatives recognized by one skilled in the art.

What is claimed is:

1. A method for producing a health test (HT) processing engine for testing a random number source, the method comprising:
receiving input directed to a set of health tests to program into the HT processing engine;
determining operations, constants, and variables used by the set of health tests identified;
mapping the constants and the variables to a memory buffer in the HT processing engine;
generating binary code operational instructions for each operation for each health test in the set of health tests;
synthesizing the HT processing engine for a chosen hardware platform for processing the binary code operational instructions; and
programming the HT processing engine to process the binary code operational instructions with the chosen hardware platform.

2. The method of claim 1, wherein the generating binary code operational instructions comprises:
developing an instruction set for each operation for each of the health tests identified, and
generating the binary code operational instructions from the instruction set.

3. The method of claim 2, further comprising loading the binary code operational instructions into a program code memory for execution by the HT processing engine.

4. The method of claim 1, wherein the generating binary code operational instructions comprises:
generating notations for the operations used in each of the health tests;
converting the notations into program instructions; and
ordering the program instructions according to algorithms required by the health tests to produce an ordered instruction set.

5. The method of claim 4, wherein the ordered instruction set is compiled into the binary code operational instructions.

6. The method of claim 1, further comprising configuring a datapath for the HT processing engine,
wherein
the datapath provides to the memory buffer data bits from an entropy source functioning as the random number source, and
the datapath provides to an arithmetic logic unit, configured to process the data bits from the entropy source, a) the data bits and b) the constants and the variables used by the set of health tests using the binary code operational instructions.

7. The method of claim 6, further comprising selecting at least one of the binary code operational instructions for processing by the arithmetic logic unit.

8. The method of claim 1, further comprising combining the binary code operational instructions for each of the health tests into a joint instruction set.

9. The method of claim 1, further comprising processing the binary code operational instructions for each of the health tests in parallel.

10. The method of claim 1, wherein the hardware platform comprises one of more of a field programmable array or an application specific integrated circuit to process the binary code operational instructions.

11. A programmable system for testing a random number source, the system comprising:
a health test HT processing engine for applying a set of health tests to an entropy source functioning as the random number source;
a controller for programming and controlling the health test processing engine;
a memory buffer in the HT processing engine; and
a program code memory for storing program codes for operations associated with the set of health tests,
wherein the controller is configured to:
receive input directed to a selection of the health tests to be programmed in the HT processing engine,
determine operations, constants, and variables used by the set of health tests.
map the constants and the variables to the memory buffer,
based on the set of the health tests to be programmed, generate binary code operational instructions for each operation for each health test in the set of health tests,
synthesize the HT processing engine for a chosen hardware platform for processing the binary code operational instructions, and
program the HT processing engine to process the binary code operational instructions with the chosen hardware platform.

12. The system of claim 11, further comprising:
a data multiplexer configured to select data at least from the entropy source for storage into the memory buffer;
an arithmetic logic unit configured to process the data from the entropy source using the binary code operational instructions; and
a program multiplexer configured to select for the arithmetic logic unit at least one or more of the binary code operational instructions to be used by the arithmetic logic unit.

13. The system of claim 12, wherein the controller is configured to develop an instruction set for each operation for each of the health tests identified, and generate the binary code operational instructions from the instruction set.

14. The system of claim 11, wherein the controller is configured to load the binary code operational instructions into a program code memory for execution by the HT processing engine.

15. The system of claim 14, wherein the controller is configured to:
generate notations for the operations used in each of the health tests; and
convert the notations into program instructions.

16. The system of claim 15, wherein the controller is configured to: order the program instructions according to algorithms required by the health tests to produce an ordered instruction set.

17. The system of claim 15, wherein the controller is configured to compile the ordered instruction set into the binary code operational instructions.

18. The system of claim 11, wherein the controller is configured to combine the binary code operational instructions for each of the health tests into a joint instruction set.

19. The system of claim 11, wherein the controller is configured to process the binary code operational instructions for each of the health tests in parallel.

20. An entropy source coupled to the programmable system of claim 11.
